(19) United States
(12) Patent Application Publication
(10) Pub. No.: US 2023/0117051 A1
(43) Pub. Date: Apr. 20, 2023

(54) Device and method for capacitive determination of a proportion of a substance in a material

(71) Applicant: Hilti Aktiengesellschaft, Schaan (LI)

(72) Inventor: Stefan KRÄMER, Ilmenau (DE)

(21) Appl. No.: 17/798,316

(22) PCT Filed: Oct. 15, 2020
(86) PCT No.: PCT/EP2020/079039

§ 371 Date: Aug. 9, 2022

(30) Foreign Application Priority Data
Feb. 25, 2020 (DE) 102020001370.8

(51) Int. Cl. G01N 27/22

(52) U.S. Cl. CPC G01N 27/221

(57) ABSTRACT

A device and a method for capacitive determination of a proportion of a substance in a material. The device includes an oscillating circuit with a coil and a plate capacitor, wherein the oscillating circuit can be excited to oscillate at different frequencies or inductances. It is provided that the frequency response or resonant frequencies of the oscillating circuit are recorded and evaluated with regard to characteristic features. On the basis of the frequencies that can be assigned to these characteristic features, the proportion of a specific substance in the material to be measured can be determined. The method for capacitive determination of a proportion of a substance in a material is based in particular on the fact that the dielectric properties of the substance are used in the method in order to determine the proportion of the substance in the material to be measured.

The present invention relates to a device and a method for capacitive determination of a proportion of a substance in a material.

### BACKGROUND OF THE INVENTION

It is known in the prior art that substance concentrations or proportions of a substance in a material to be examined can be determined by optical methods. In these conventional methods, which are known from the prior art, in particular the optical properties of the substance of which the proportion is to be determined are used to determine the proportion. Many optical methods are based on the fact that the substance of which the proportion is to be determined is dissolved in a liquid and the solution obtained is illuminated. The optical response of the illumination is recorded and plotted in the form of spectra. The concentration of the substance can then be deduced from the spectra of the absorbed and/or reflected radiation.

### SUMMARY OF THE INVENTION

Such an optical measuring method is described for example in DE 41 22 925 A1. Described therein is an optical spectrometer with an illumination device coupled to at least one optical waveguide for illuminating a substance to be spectroscopically examined that is contained in a measurement sample chamber, the spectrometer comprising a monochromator device and a detector arrangement. The disadvantage of optical methods as described in DE 41 22 925 A1 is that optical components have to be used to determine the concentration. The use of optical components, however, often leads to high costs and a considerable sensitivity of the measurement setup obtained, so that the measurement setup cannot be used outside a protected laboratory atmosphere. In this respect, the use of optical methods and devices that are based on such optical methods is very limited, if not impossible, in reality and in particular in locations with high potential for vibration, noise and/or pollution, such as for example on a construction site.

Furthermore, optical methods are accompanied by the disadvantage that a liquid is always required in order to dissolve the substance to be measured. However, under some circumstances such a - preferably clean - solvent liquid is not always available. The liquid is required in particular to examine the transitions or changes in the refractive indices between the optical measuring system and the sample. Due to the requirement for a solvent liquid, it is not possible for example to determine by optical methods proportions of substances in non-liquid-soluble substances or in air.

An object of the present invention is to overcome the disadvantages and deficiencies of the prior art described above and to provide a device and a method for capacitive determination of a proportion of a substance in a material. Experts would welcome it if the improved method and the improved device could also be used to determine proportions of substances in non-water-soluble materials and if measurements were also possible in air. It is also alternately or additionaly intended that the device to be provided can also be used in harsh environments, such as on construction sites or the like, where vibrations and heavy soiling are generally to be expected. In particular, it is alternately or additionaly intended to provide a robust, stable and insensitive device. Another additional or alternate concern is to make the method to be provided inexpensive and user-friendly.

According to the invention, a device for capacitive determination of a proportion of a substance in a material is provided, the device comprising an oscillating circuit with a coil and a plate capacitor. The device is characterized in that the plate capacitor can be filled with the material as a dielectric, a frequency response of the dielectric being recorded and evaluated in order to determine the proportion of the substance in the material.

In a second aspect, the invention provides a method for capacitive determination of a proportion of a substance in a material. The method is characterized by the following method steps:
a) providing a device,
b) filling a plate capacitor of the device with the material, wherein the proportion of a substance in the material is to be determined,
c) setting different frequencies or inductances in an oscillating circuit of the device,
d) recording a frequency response or resonant frequencies of the material,
e) evaluating the frequency response or the resonant frequencies by searching for characteristic features,
f) determining the proportion of the substance using characteristic frequencies fc, which can be assigned to the characteristic features.

One field of application of the invention is the determination of a proportion of quartz in a dust sample. The quartz content in a dust to be measured represents important information because quartz is associated with diseases such as silicosis or lung cancer. Since in many countries increasing efforts are being made to protect workers in mining or on construction sites better than before from high levels of dust exposure and the accompanying negative health effects, there is great interest in practicable, realistic and cost-effective technical solutions for examining dust. Experts would particularly welcome it if a possible way in which a quartz content in a dust to be measured can be determined quickly and reliably could be created, in order to be able to take suitable protective measures for the workers concerned.

It is therefore conceivable to use the device as a “dust dosimeter”, which the workers can carry with them on a construction site and which determines the amount of quartz to which the construction worker is exposed in the course of the day. By analogy with a radiation dosimeter, the device can record and save the data acquired or transmit them to another device for further processing. For the purposes of the invention, it may also be preferred that the device emits optical and/or acoustic warning signals, which for example indicate to the worker that a maximum daily exposure amount of quartz has been reached or will soon be reached. For the purposes of the invention, it may also be preferred that the device is arranged on a vacuuming device or an air cleaner, so that the quartz content in the dust in a surrounding area of the vacuuming device or the air cleaner can be determined. Furthermore, for the purposes of the invention, it may be preferred that the device is used in the surrounding area of or on a dust-generating device, such as a power tool, in order to examine the composition of the dust directly at its point of origin and in particular to determine the quartz content.

One advantage of the method and the device is that it is possible to dispense with expensive and sensitive optical elements and measurement setups. As a result, the invention provides an inexpensive and insensitive technical solution for determining a proportion of a substance in a material to be measured, here preferably dust. This is achieved in particular by the method and the use of the device for determining a proportion of a substance being carried out capacitively and by the dielectric properties of the substance of which the proportion is to be determined being used to determine the proportion of the substance in the dust . For the purposes of the invention, it is preferred in particular that the determination of the proportion of the substance in the dust takes place capacitively.

For the purposes of the invention, it is particularly preferred that in the context of the method the dielectricity or the dielectric constant of the material to be measured is measured at different frequencies in order to determine the quartz content in a dust sample. For this purpose, in particular a frequency spectrum is measured in order to be able to obtain and evaluate a dielectric response of the dust sample. For the purposes of the invention, it is preferred that, at the beginning of the method, a short pulse or a falling edge is applied to the electromagnetic oscillating circuit of the device.

For the purposes of the invention, it is preferred to charge the capacitor with a short pulse of known energy or voltage. After the capacitor has been charged, the energy or voltage is removed abruptly, this being possible for example by means of a short circuit across the coil of the electromagnetic oscillating circuit. For the purposes of the invention, it is preferred that the excitation of the oscillating circuit can be carried out analogously. Preferably, when the plate capacitor is being charged or when the oscillating circuit is being excited, the harmonic components of the excitation are selected or set at such a high frequency that they are set up to excite the quartz resonance.

In response to this, the oscillating circuit begins to oscillate at its resonant frequency. The resonant frequency can preferably be recorded with the control unit of the device. The frequency can also be adjusted with the aid of diodes, capacitance diodes and/or potentiometers until the frequencies relevant for quartz are reached. The dielectricity or the dielectric constant of the material to be measured can be determined from the values set for the inductance L. For the purposes of the invention, it is preferred that for example the quartz content in dust correlates with a change in the dielectricity or the dielectric constant of the dust in the range of the resonant frequency. In other words, the relation applies that “the greater the change in the dielectricity or the dielectric constant at the resonant frequency, the more quartz is contained in the dust”.

Another advantage that is achieved with the invention is that it is also possible to measure materials that are not water-soluble or liquid-soluble. In particular, the method and the device allow the determination of a proportion of a substance in air. The advantages achieved with the invention are therefore in particular that capacitive measurements can be carried out with mechanically insensitive components and that no liquid solution medium is required for carrying out the measurements.

In the context of the present invention, a device which comprises an oscillating circuit with a coil and a plate capacitor is provided. For the purposes of the invention, it is provided that the device is set up to carry out the method. The coil may preferably be a wire coil, the properties of which are preferably described by the inductance L. For the purposes of the invention, it is preferred that the coil to be used and its properties are selected depending on the substance to be detected or the material to be measured, as well as depending on the properties of the plate capacitor together with which the coil forms the oscillating circuit of the device. For example, a value of around 100 µH can be chosen as the starting point for operating the oscillating circuit. A person skilled in the art knows that this value can vary by several orders of magnitude, in particular with the size of the device.

For the purposes of the invention, it is preferred that the plate capacitor comprises two plates, between which a voltage can be applied. Two alternative approaches can be used to carry out the method. According to a first method, a sinusoidal excitation signal may be applied to the oscillating circuit of the device (“sine sweep”), a constant voltage amplitude preferably being used. In response to this excitation, the voltage drop across the capacitor is recorded as if the electromagnetic oscillating circuit were a voltage divider. According to this first method, the voltage is recorded as a measured variable over a predetermined frequency, which can produce a voltage-frequency diagram. FIG. 2 shows such a digram by way of example.

This first method can be described by the following method steps:
a) providing a device,
b) filling a plate capacitor of the device with the material, wherein the proportion of a substance in the material is to be determined,
c) setting different frequencies in an oscillating circuit of the device,
d) recording a frequency response of the material,
e) evaluating the frequency response by searching for characteristic features,
f) determining the proportion of the substance using characteristic frequencies fc, which can be assigned to the characteristic features.

According to a second method, an electromagnetic oscillating circuit in which inductances L of different sizes can be set or “looped in” is provided. In this second method, the different inductances L represent the specified variable. The electromagnetic oscillating circuit is then excited to oscillate, the resonant frequency being recorded as a measured variable and/or plotted against the inductance. Frequency-inductance diagrams can thereby be obtained. In the context of this second method, it is preferred that the electromagnetic oscillating circuit is designed such that, when a first inductance is set, it oscillates at a first resonant frequency of quartz. This design is achieved in particular by setting a specific measuring inductance as a specified variable. The measurement may then be repeated for different inductances that can be looped in the oscillating circuit, the oscillating circuit preferably oscillating at a second or further resonance of quartz during this second or every further measurement.

This second method can be described by the following method steps:
a) providing a device,
b) filling a plate capacitor of the device with the material, wherein the proportion of a substance in the material is to be determined,
c) setting different inductances in an oscillating circuit of the device,
d) recording resonant frequencies of the material,
e) evaluating the resonant frequencies by searching for characteristic features,
f) determining the proportion of the substance using characteristic frequencies fc, which can be assigned to the characteristic features.

For the purposes of the invention, it is preferred that sufficiently large voltage amplitudes are used to excite the oscillating circuit. A voltage amplitude is regarded as “sufficiently large” for the purpose of the invention if it is set up to excite a resonance in the oscillating circuit.

The plates of the plate capacitor are preferably aligned substantially parallel to one another. For the purposes of the invention, it is preferred that the plate capacitor comprises connections for a voltage source and/or for a control unit. The parameters of the plate capacitor or its plates may preferably be selected depending on the substance to be detected or depending on the material to be measured. These parameters are for example the size of the plates of the plate capacitor or their distance from one another. The geometrical parameters of the plate capacitor preferably define a volume into which the dust to be measured can be filled as a dielectric.

For the purposes of the invention, it is preferred that the material in which the measurement takes place and which is introduced into the measurement volume between the plates of the plate capacitor is preferably referred to as the “material to be measured”. In a particularly preferred exemplary embodiment of the invention, the material to be measured is dust. This dust may occur for example on a construction site, in particular when a substrate such as a wall, concrete, limestone or the like is worked with a power tool such as a core drill, a saw, an angle or cut-off grinder or a hammer drill, without being limited to these applications. Quartz may be contained in concrete or masonry in particular, so that dust containing quartz can occur when working such substrates. The inventor has recognized that the density of concrete and quartz is approximately similar or comparable, so that this fact can be used for the capacitive determination of the quartz content in a dust sample.

In the context of the invention, the substance of which the proportion in the material to be measured is to be determined is referred to as the “substance of which the proportion is to be determined”. In a particularly preferred exemplary embodiment of the invention, the substance of which the proportion is to be determined is quartz. Quartz has the chemical composition SiO2 and in particular takes the form of a crystalline lattice structure. Due to its structure, quartz can be polarized, the polarization of a substance allowing an unambiguous identification of a substance if its dielectric constant is measured and evaluated at characteristic frequencies. For the present invention, the relevant, characteristic frequencies for quartz are in a range from 10^4 to 10 \^6 Hz, i.e. around 10 to 1000 kHz, and these frequencies can be measured electrically without any problems. The inventor has recognized that the dielectric properties of substances, in particular quartz, can be used to determine the proportion of the substance in a material to be measured, such as dust.

In the context of the present invention, the dust as the material to be measured is introduced as a dielectric between the plates of the plate capacitor. The properties of the plate capacitor can preferably be described with the capacitance C of the electromagnetic oscillating circuit which is part of the device.

In a next step, different frequencies are set in the electromagnetic oscillating circuit of the device.

In other words, different frequencies can be applied to the oscillating circuit. For the purposes of the invention, it is preferred that the device comprises a voltage source which is set up to excite the oscillating circuit to oscillate. In other words, the oscillations of the oscillating circuit can be implemented by a voltage source, the voltage to be provided by the voltage source preferably being made to match the inductance L of the coil, the capacitance C of the capacitor and the material properties of the material to be measured, as well as the substance of which the proportion is to be determined. In other words, the voltage to be provided by the voltage source is selected depending on the variables just mentioned. The material properties of the material to be measured and of the substance of which the proportion is to be determined may be for example its density, dielectric constant or the like. For the purposes of the invention, it is preferred in particular that the determination of the proportion of the substance in the dust takes place capacitively.

For the purposes of the invention, it is preferred that the frequencies which are applied to the dielectric or the plate capacitor, i.e. which are measured, lie in a range from 0 to 1000 kHz, preferably in a range from 10 to 800 kHz and most preferably in a range from 100 to 500 kHz. These frequency ranges are particularly advantageous and suitable for determining a proportion of quartz in the dust, since characteristic features in the frequency response for quartz in a specific test setup are for example around 150 and 250 kHz. A person skilled in the art knows that the specified values may depend on the size, the geometry and/or the water content of the material to be measured, which is why it is preferred for the purposes of the invention that calibration measurements are carried out with the measurement setup to be used, for example to determine the position of the characteristic frequencies. For the purposes of the invention, it is preferred that the frequencies are resonant frequencies of the oscillating circuit that are passed through by different variables being applied to the oscillating circuit or its components. For the purposes of the invention, it is preferred that the resonant frequencies of the electromagnetic oscillating circuit can be recorded or measured by a control unit, which is explained further below, wherein the control unit can be part of the device. The control unit may preferably be formed as a microcontroller. It is also preferred for the purposes of the invention that a quality of the electromagnetic oscillating circuit is measured by the control unit. For this purpose, a voltage drop across the coil and the capacitor and a phase angle are measured and evaluated by the microcontroller.

For the purposes of the invention, it is preferred that the quality of the electromagnetic oscillating circuit can be used as a correction variable in order to exclude measurement errors that can occur when the resonant frequencies of different substances of which the proportions in a material are to be determined are very similar or in are in a similar range. In addition to measuring the dielectricity or the dielectric constant of the material at a specific frequency, the quality of the electromagnetic oscillating circuit can preferably be used to distinguish the resonances or frequencies of the first and second substances from one another.

For the purposes of the invention, it is particularly preferred that the electromagnetic oscillating circuit of the device is excited to oscillate at different frequencies, with a frequency response of the dielectric, i.e. of the dust to be measured, being subsequently recorded and evaluated to determine the proportion in the dust of the substance of which the proportion is to be determined. For the purposes of the invention, these steps are preferably also referred to as “setting different frequencies in an oscillating circuit of the device” and as “recording a frequency response of the dust”.

For the purposes of the invention, it is preferred that the device comprises a control unit which is set up to record the frequency response of the dielectric. The control unit of the device is preferably formed as a microcontroller. The control unit is preferably a preferably freely programmable processor that can have integrated peripheral functions. For the purposes of the invention, the control unit is set up in particular to control the sensors and/or recording devices of the device. It may also be set up to store and/or evaluate the measured values recorded with the sensors and/or recording devices.

In the context of the present invention, the frequency response of the dust to be measured is recorded and evaluated with the microcontroller. In particular, the voltage between the plates of the plate capacitor is measured and plotted against the different frequencies, whereby a frequency-voltage diagram is obtained (see FIGS. 2a and 2b).

For the purposes of the invention, it is preferred that the control unit is also set up to apply different frequencies to the dielectric. This can be achieved for example by the control unit being able to switch a voltage on or off. For the purposes of the invention, it may also be preferred that the electromagnetic oscillating circuit is excited by a voltage source. Most preferred for the purposes of the invention is the use of a voltage source controlled by the control unit in order to excite the electromagnetic oscillating circuit or to apply different frequencies to the dielectric.

In other words, the microcontroller can also be used to apply different frequencies to the electromagnetic oscillating circuit of the device, the reaction of the dielectric to the passage through the different frequencies being recorded and evaluated in the context of the present invention in order to determine the proportion of a substance in dust.

For the purposes of the invention, it is most particularly preferred that the response of the material to be measured is recorded in the form of a voltage. For example, the frequency response of the dielectric, i.e. of the material to be measured, can be plotted in a frequency-voltage diagram. The frequencies which are applied to the oscillating circuit or with which the oscillating circuit is excited are plotted on the x-axis of the diagram, while the frequency response of the dust is plotted on the y-axis of the diagram. The frequency response of the material to be measured can then be evaluated by searching for characteristic features in the plot. In particular, the frequency-voltage diagram can be examined for characteristic features of the curve. According to the alternative second method, a frequency-inductance diagram may preferably be evaluated. In other words, characteristic peaks can be searched for in the frequency-voltage diagram, the peaks being determined in particular by characteristic frequencies fc for a specific material. For the purposes of the invention, this preferably means that different substances in the material to be measured can be identified by the location of characteristic features in the frequency-voltage diagram. Such peaks for quartz are for example at frequencies of approx. 150 and 250 kHZ. In other words, in the context of the present invention, the presence of quartz in a dust sample to be measured can be inferred if peaks or abnormalities occur at frequencies of approx. 150 and 250 kHz in the frequency-voltage diagram that represents the frequency response of the dust. For the purposes of the invention, it is preferred that the characteristic frequencies fc in the case of crystalline materials often result from the lattice structure of the material. In a preferred exemplary embodiment of the invention, this leads in the desired determination of a proportion of quartz in a dust sample to the characteristic frequencies fc1≈ 150 kHZ and fc2≈ 250 kHZ.

For the purposes of the invention, it is preferred that greater changes in the frequencies are achieved by setting inductances of different sizes, the inductance describing properties of the coil of the oscillating circuit. For example, as shown solely schematically as SW in FIG. 1, a relay, an analog switch and/or a gyrator circuit may be used for setting inductances of different sizes. Tests have shown that, for example, an analog switch or a gyrator circuit are particularly insensitive to vibrations. For the purposes of the invention, it is therefore preferred that the device comprises a relay, an analog switch and/or a gyrator circuit for setting different frequencies in the oscillating circuit. Preferably, in this way the inductance of the coil of the oscillating circuit can be changed, a change in the inductance of the coil advantageously leading to a change in the frequencies of the oscillating circuit. The setting of the different inductances may be performed for example by electrically looping in the coil of the oscillating circuit.

For the purposes of the invention, it is preferred that smaller changes in the frequencies are achieved by setting capacitances of different sizes, the capacitance describing for example properties of capacitance diodes that can be connected in series or in parallel with the plate capacitor of the oscillating circuit. For the purposes of the invention, it is preferred that the device comprises capacitance diodes for setting different frequencies in the oscillating circuit, the capacitance diodes being connectable in series or in parallel with the plate capacitor of the oscillating circuit. It is therefore preferred for the purposes of the invention that the capacitance of the capacitance diodes can be used for setting different frequencies in the oscillating circuit. Depending on the wanted sign of the frequency change within the oscillating circuit, the capacitance diodes can be connected in series or in parallel with the plate capacitor of the oscillating circuit. For the purposes of the invention, it is preferred that the capacitance diodes represent electrically controlled capacitances, their control preferably taking place by means of the control unit.

For the purposes of the invention, it is preferred that the variable inductances of the coil and capacitances of the diodes are set by the control unit. This process is preferably also referred to as looping in. By setting different inductances and capacitances, the (resonant) frequency of the electromagnetic oscillating circuit of the device changes and different frequencies are applied to the material to be measured. By means of the properties of the material of the dielectric and/or by means of the properties of the substance of which the proportion is to be determined, the wanted proportion of substance can thus be determined on the basis of the electrical parameters of the electromagnetic oscillating circuit.

The inventor has recognized that the relative permittivity or the dielectric constant of the material to be measured is proportional in good approximation to a quartz content in the volume of material or dust of the capacitor. So if for example a dielectric constant of 1 is measured when measuring with quartz-free dust and a dielectric constant of 5 is measured when measuring with a material with a high quartz content, the quartz content of which is almost 100%, then when measuring dust with an unknown quartz content it can be inferred from a measured dielectric constant of 3 that the quartz content in this dust sample is in a range of approx. 50%. This assignment is also based on the knowledge that quartz and concrete have similar densities. This determined proportion of quartz may advantageously be correlated with the air volume from which the dust sample was extracted or filtered out in order to determine the quartz content of the breathable air, for example of a worker on a construction site.

For the purposes of the invention, it is preferred that changes in the frequencies are brought about by setting different inductances, the inductance describing properties of a coil of the oscillating circuit of the device. A relay may be used for example for setting inductances of different sizes. For the purposes of the invention, it is also preferred that changes in the frequencies are brought about by setting different capacitances, the capacitance describing properties of capacitance diodes which can be connected in series or in parallel with the plate capacitor of the oscillating circuit.

In an exemplary embodiment, the invention relates to a sensor device for determining a proportion of a substance in dust, the sensor device having a plate capacitor which can be filled with dust as a dielectric, a frequency response of the dielectric or a shift in a frequency spectrum being measured and evaluated in order to determine the proportion of the substance in the dust. For the purposes of the invention, it is most particularly preferred that the substance of which the proportion in the dust is to be determined is quartz. There is great interest in information about the proportion of quartz in dust samples, since quartz is believed to have properties which are harmful to health.

For the purposes of the invention, it may also be preferred that the capacitor is not necessarily filled with the material to be measured, but that the capacitor measures into the material to be measured from one side. The material to be measured may be in the spatial proximity of the plate capacitor, the material to be measured being able to cause a change in measured variables that can be recorded with the capacitor. These changes can be detected and evaluated with this capacitive measurement method.

In a further exemplary embodiment of the invention, it is preferred that an electromagnetic oscillating circuit with variable frequency is used for the measurement, the resonant frequency, quality and voltage drop of the electromagnetic oscillating circuit being measured via the coil and the capacitor. In addition, the resonant frequency of the electromagnetic oscillating circuit can be adapted using different inductances and capacitances. For the purposes of the invention, it is preferred that a plate capacitor is used for carrying out the method for determining a proportion of a substance by introducing the material to be measured, here a dust sample, between the plates of the plate capacitor.

For the purposes of the invention, it is preferred that a second electromagnetic oscillating circuit can be used, the waveform of which can be superposed on the waveform of the previously used plate capacitor to improve the measurement.

In other words, it may be preferred in the context of thedevice that the device comprises a second oscillating circuit, the measured values of which can be superposed with the measured values of the first oscillating circuit in order to further improve the accuracy and reliability of the determination method and the device.

The provision of a second electromagnetic oscillating circuit takes into account the knowledge that an “ideal” frequency of the oscillating circuit may deviate from frequencies that actually occur. This may for example be attributable to air humidity or a thermal expansion of the plate capacitor, without this list being exhaustive. A second electromagnetic oscillating circuit, into which no dust is filled, may therefore be used. For the purposes of the invention, it is preferred to excite the first and the second oscillating circuit substantially identically and substantially at the same time. Depending on the phase shift between the oscillating circuits, the voltage values of the two oscillating circuits add up to a maximum of twice the value of the voltage of one of the two oscillating circuits, or the voltages cancel each other out, so that a total voltage of 0 V is obtained. If the first electromagnetic oscillating circuit is filled with the material to be measured, its oscillation frequency preferably changes. There is an interference between the preferably wave-shaped voltage curves, the frequency of the beat of the two oscillating circuits advantageously being proportional to the quartz content of the material that was filled into the plate capacitor of the first oscillating circuit. It is an essential advantage of this embodiment of the invention that any influences of air humidity or temperature remain outside the evaluation of the interference values or the beat of the two oscillating circuits and do not falsify the quartz content thus determined.

Further advantages can be found in the following description of the figures. The figures, the description and the claims contain numerous features in combination. A person skilled in the art will expediently also consider the features individually and combine them to form useful further combinations.

### BRIEF DESCRIPTION OF THE DRAWINGS

In the figures, identical and similar components are denoted by the same reference signs. In the figures:

FIG. 1 shows a schematic representation of a preferred embodiment of the device; and

FIGS. 2a and 2b show a plot of the recorded voltage against different frequencies that can be set in the oscillating circuit for determining the wanted proportion of a substance.

### DETAILED DESCRIPTION

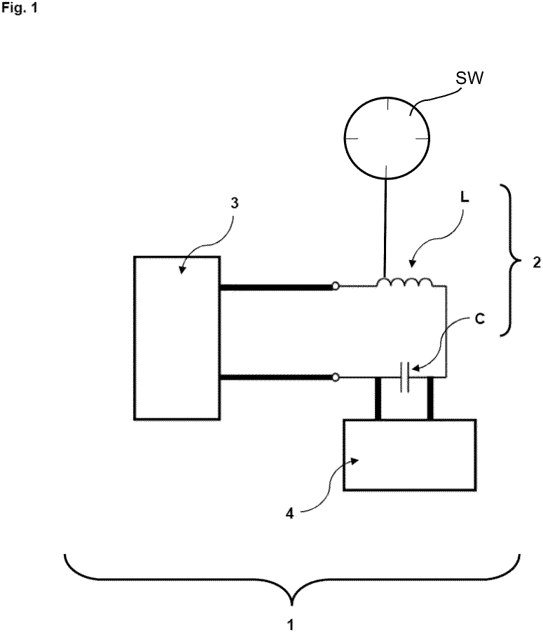

FIG. 1 shows a schematic representation of a preferred embodiment of the device 1. The device 1 comprises an electromagnetic oscillating circuit 2, which in turn comprises a coil L and a capacitor C. The capacitor C is formed as a plate capacitor. It preferably has two plates between which there is an electric field. A material, such as for example dust, can be filled into the volume that is formed between the plates of the plate capacitor. For the purposes of the invention, it is preferred that this material is to be examined for its constituent substances, as well as their proportions in the material.

Different frequencies can be applied to the oscillating circuit 2. The corresponding oscillations are excited by a voltage source 3. The voltage source 3 may preferably be formed as a frequency generator or a sine-wave generator. For the purposes of the invention, it may also be preferred that the control unit 4 and the voltage source 3 form a unit.

Furthermore, the device 1 may comprise a control unit 4, which is preferably formed as a microcontroller. For the purposes of the invention, it is preferred that the control unit 4 is set up to record the frequencies in the oscillating circuit 2 and its quality. In addition, the control unit 4 may be set up to electrically set or “loop in” the capacitances and inductances of the oscillating circuit 2. A relay, an analog switch and/or a gyrator circuit shown schematically as SW can also set different frequencies in the oscillating circuit 2. For the purposes of the invention, it is preferred that the control unit 4 comprises a device for voltage measurement, which may be formed for example as an oscilloscope with an integrated option for performing a Fast Fourier transformation. For the purposes of the invention, it is particularly preferred that the control unit 4 is intended in particular to carry out frequency measurements.

The oscilloscope is preferably set up to record an amplitude of the frequency falling across the capacitor C. For the purposes of the invention, it is preferred that the amplitude of the frequency falling across the capacitor C represents the measured variable in the method. For the purposes of the invention, it is particularly preferred that the amplitude is recorded over the sinusoidal frequency. This preferably means the excitation of the electromagnetic oscillating circuit 2 with a preferably sinusoidal excitation signal, which can be generated by a frequency generator. The peak values of the voltage of the empty capacitor C are then compared with the peak values of the capacitor C filled with dust containing quartz. The resonant frequencies can be determined by the position of the peaks in the frequency-inductance diagrams or the voltage-frequency diagrams.

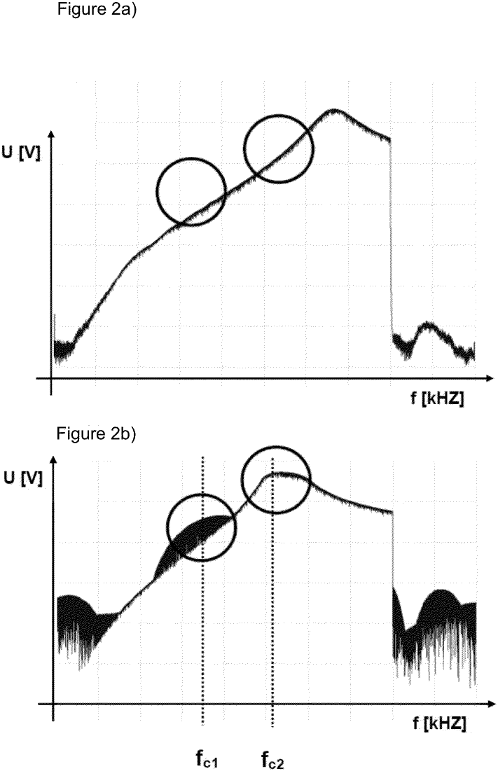

FIGS. 2a and 2b show a plot of the recorded voltage against different frequencies that can be set in the oscillating circuit 2 for determining the wanted proportion of a substance. FIG. 2a shows a voltage-frequency diagram for a quartz-free dust, while FIG. 2b shows a voltage-frequency diagram for a quartz-containing dust. In other words, the material to be measured in FIG. 2a is quartz-free dust and the material to be measured in FIG. 2b is quartz-containing dust. On the x-axis of the voltage-frequency diagram, the frequency or the resonant frequency f of the oscillating circuit is plotted in the unit kilohertz (kHz), while on the y-axis of the voltage-frequency diagram the voltage U recorded by the control unit 4 is plotted in the unit volt (V). The diagrams shown in FIGS. 2a and 2b allow the frequency response to be evaluated by searching for characteristic features, as according to the first evaluation method using voltage-frequency diagrams. The proportion of the substance is determined in particular using characteristic frequencies fc, which can be assigned to the characteristic features.

FIG. 2b clearly shows the characteristic frequencies fc1 and fc2, which are at frequencies of approximately 150 kHz and 250 kHz. The position of these characteristic frequencies fc1 and fc2 suggests that quartz is present in the examined dust with which the plate capacitor C of the device 1 is filled. In the example of the invention shown in FIGS. 2a and 2b, quartz is the substance of which the proportion in the material to be measured, here dust, is to be determined.

### LIST OF REFERENCE SIGNS

1 Device
2 Oscillating circuit
3 Voltage source
4 Control unit
L Coil
C Capacitor
SW Relay, Analog Switch and/or a Gyrator Circuit

What is claimed is:

1-13. (canceled)

14. A device for capacitive determination of a proportion of a substance in a material, the device comprising:
an oscillating circuit with a coil and a plate capacitor, the plate capacitor fillable with the material as a dielectric, a frequency response of the dielectric being recorded and evaluated in order to determine the proportion of the substance in the material.

15. The device as recited in claim 14 wherein the determination of the proportion of the substance in the material takes place capacitively.

16. The device as recited in claim 14 further comprising a voltage source set up to excite the oscillating circuit to oscillate.

17. The device as recited in claim 14 further comprising a controller set up to record the frequency response of the dielectric.

18. The device as recited in claim 17 wherein the controller is also set up to apply different frequencies to the dielectric.

19. The device as recited in claim 18 wherein frequencies applied to the dielectric lie in a range from 0 to 1000 kHz.

20. The device as recited in claim 19 wherein the frequencies applied to the dielectric lie in a range from 10 to 800 kHz.

21. The device as recited in claim 20 wherein the frequencies applied to the dielectric lie in a range from 100 to 500 kHz.

22. The device as recited in claim 14 further comprising capacitance diodes for setting different frequencies in the oscillating circuit.

23. The device as recited in claim 22 wherein the capacitance diodes are connectable in series or in parallel to the plate capacitor of the oscillating circuit.

24. The device as recited in claim 14 further comprising a relay, an analog switch or a gyrator circuit for setting different frequencies in the oscillating circuit.

25. A method for capacitive determination of a proportion of a substance in a material, the method comprising the following steps:
a) providing the device as recited in claim 14;
b) filling the plate capacitor with the material, wherein the proportion of the substance in the material is to be determined;
c) setting different frequencies or inductances in an oscillating circuit of the device;
d) recording a frequency response or resonant frequencies of the material;
e) evaluating the frequency response or the resonant frequencies by searching for characteristic features;
f) determining the proportion of the substance using characteristic frequencies assignable to the characteristic features.

26. The method as recited in claim 25 wherein dielectric properties of the substance are used to determine the proportion of the substance in the material.

27. The method as recited in claim 25 wherein changes in frequencies are brought about by setting the different inductances, the inductances describing properties of a coil of the oscillating circuit.

28. The method as recited in claim 25 wherein changes in the frequencies are brought about by setting different capacitances, the capacitances describing properties of capacitance diodes or of the plate capacitor of the oscillating circuit.
